(19) United States
(12) Patent Application Publication
(10) Pub. No.: US 2009/0049132 A1
(43) Pub. Date: Feb. 19, 2009

(54) DEVICE, SYSTEM, AND METHOD OF ROUTING ELECTRONIC MAIL

(76) Inventor: Moshe Livne Gutovski, Raanana (IL)

Correspondence Address: EMPK & Shiloh, LLP;c/o Landon IP, Inc., 1700 Diagonal Road, Suite 450, Alexandria, VA, 22314, US

(21) Appl. No.: 11/838,920

(22) Filed: Aug. 15, 2007

(51) Int. Cl. G06F 15/16

(52) U.S. Cl. 709/206; 709/239

(57) ABSTRACT

Device, system, and method of handling electronic mail. For example, a method includes: extracting from a recipient field of an electronic mail message intended for transmission a string representing a telephone number of an intended recipient; based on said string, obtaining an electronic mail address of the intended recipient from a remote database that associates telephone numbers with respective electronic mail addresses; and replacing said string with said electronic mail address in the recipient field of the electronic mail message.

### FIELD

Some embodiments of the invention are related to the field of communication, and more particularly to electronic mail.

### BACKGROUND

An electronic mail (“email”) system allows users to compose, send and receive messages, for example, textual messages, photographs, documents, and various types of attached files. An email message is composed using an email client software, or using a web-based email (web-email) interface, that allows the user to type the email address of the recipient in a “To” field.

Unfortunately, email addresses may be long and cumbersome, for example, “Condoleezza.RiceWhiteHousegov” Such email addresses and their exact spelling may not be easily remembered by users, and the typing process of such email addresses is error-prone. Furthermore, an error in one or more letters or characters of the email address, typically results in failure in delivering the email message to the intended recipient.

### SUMMARY

Some embodiments of the invention include, for example, devices, systems, and methods of handling and/or routing electronic mail (Email).

Some embodiments include, for example, a method of handling electronic mail, the method including: extracting from a recipient field of an electronic mail message intended for transmission a string representing a telephone number of an intended recipient; based on the string, obtaining an electronic mail address of the intended recipient from a remote database that associates telephone numbers with respective electronic mail addresses; and replacing the string with the electronic mail address in the recipient field of the electronic mail message.

In some embodiments, the method includes: intercepting a command to send out the electronic mail message from an electronic mail interface.

In some embodiments, the method includes: after the replacing, authorizing the electronic mail interface to send out the electronic mail message.

In some embodiments, the extracting includes: identifying a sequence of characters in the recipient field which represents a telephone number based on one or more pre-defined identification rules.

In some embodiments, the method includes: after the extracting and prior to the searching, re-formatting the string in accordance with one or more pre-defined formatting rules.

In some embodiments, the re-formatting includes: performing at least one operation selected from a group consisting of: removing a parentheses character, replacing a parentheses character, removing a period character, replacing a period character, removing a space character, replacing a space character, removing a minus character, and replacing a minus character.

In some embodiments, the searching includes: transmitting a query to a remote web server associated with a remote data repository storing the database, the query including the string; and receiving from the remote web server a response including the electronic mail address.

In some embodiments, the transmitting includes: transmitting the query to the web server prior to transmission of the electronic mail message from the electronic mail interface to an electronic mail server.

In some embodiments, the extracting includes: performing an operation selected from a group consisting of: extracting from a “TO” field of the electronic mail message, extracting from a “CC” field of the electronic mail message, and extracting from a “BCC” field of the electronic mail message.

In some embodiments, the method includes: prior to the searching, adding to the string at least one of: a prefix representing a local area telephone code, and a prefix representing a country telephone code.

In some embodiments, the adding of the prefix includes: adding the prefix based on at least one of: a country code definition of an operating system on which the electronic mail interface runs, a time zone definition of the operating system, a language definition of the operating system, an indication of a sender's country, an indication of a recipient's country, an indication of a sender's city, an indication of a recipient's city.

In some embodiments, the method includes: storing in a folder of sent electronic mail messages of the electronic mail interface a copy of the electronic mail message, wherein the recipient field of the copy includes an item selected from a group consisting of: the string; the electronic mail address; and the string, the electronic mail address, and an indication that the electronic mail address corresponds to the string.

In some embodiments, the method includes: adding an advertisement item to the electronic mail message.

In some embodiments, the method includes: selecting the advertisement item from a repository of advertisement items based on at least one of: an information item associated with a recipient of the electronic mail message, an information item associated with a sender of the electronic mail message, and a contextual analysis of the electronic mail message.

In some embodiments, the method includes: storing in a local cache a copy of the string and the electronic mail address; and prior to a subsequent searching of the database, searching the local cache.

In some embodiments, the method includes: extracting from a recipient field of the electronic mail message intended for transmission another string comprising at least one non-digit character; based on the other string, obtaining a translated electronic mail address of the intended recipient from a remote database that associates contact details with respective electronic mail addresses; and replacing the other string with the translated electronic mail address in the recipient field of the electronic mail message.

In some embodiments, an apparatus includes: an extractor to extract from a recipient field of an electronic mail message intended for transmission a string representing a telephone number of an intended recipient; a translator to obtain, based on the string, an electronic mail address of the intended recipient from a remote database that associates telephone numbers with respective electronic mail addresses; a replacer to replace the string with the electronic mail address in the recipient field of the electronic mail message; and an interceptor to intercept a command to send out the electronic mail message from an electronic mail interface.

In some embodiments, a communication system for handling and/or routing electronic mail includes a remote database that associates telephone numbers with respective electronic mail addresses; and the communication system further includes a communication device which includes: an interceptor to intercept a command to send out an electronic mail message from an electronic mail interface; an extractor to extract from a recipient field of the electronic mail message intended for transmission a string representing a telephone number of an intended recipient; a translator to obtain, based on the string, an electronic mail address of the intended recipient from the remote database; and a replacer to replace the string with the electronic mail address in the recipient field of the electronic mail message.

In some embodiments, the communication device includes: a personal computer, a laptop computer, a Personal Digital Assistant device, an electronic mail device, a wireless communication device, and/or a mobile phone.

Some embodiments include, for example, a computer program product including a computer-useable medium including a computer-readable program, wherein the computer-readable program when executed oil a computer causes the computer to perform methods in accordance with some embodiments of the inventions.

Some embodiments of the invention may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system able to handle electronic mail in accordance with a demonstrative embodiment of the invention; and

FIG. 2 is a schematic flow-chart of a method of handling electronic mail in accordance with a demonstrative embodiment of the invention.

### DETAILED DESCRIPTION

In the following detailed description, numerous specific details are set forth in order to provide a thorough understanding of some embodiments of the invention. However, it will be understood by persons of ordinary skill in the art that embodiments of the invention may be practiced without these specific details. In other instances, well-known methods, procedures, components, units and/or circuits have not been described in detail so as not to obscure the discussion.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein includes, for example, “multiple” or “two or more”. For example, “a plurality of items” includes two or more items.

Although portions of the discussion herein relate, for demonstrative purposes, to wired links and/or wired communications, embodiments of the invention are not limited in this regard, and may include one or more wired or wireless links, may utilize one or more components of wireless communication, may utilize one or more methods or protocols of wireless communication, or the like. Some embodiments of the invention may utilize wired communication and/or wireless communication.

Some embodiments of the invention may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a non-mobile or non-portable device, a wireless communication station, a wireless communication device, a wireless Access Point (AP), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11e, 802.11g, 802.11h, 802.11i, 802.11n, 802.16, 802.16d, 802.16e standards and/or future versions and/or derivatives and/or Long Term Evolution (LTE) of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, a wired or wireless handheld device (e.g., BlackBerry, Palm Treo), a Wireless Application Protocol (WAP) device, or the like.

Some embodiments of the invention may be used in conjunction with one or more types of wireless communication signals and/or systems, for example, Radio Frequency (RF), infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth (RTM), Global Positioning System (GPS), Wi-Fi, Wi-Max, ZigBee (TM), Global System for Mobile communication (GSM), 2G, 2.5G, 3G, 3.5G, or the like. Embodiments of the invention may be used in various other devices, systems and/or networks.

The term “recipient fields” as used herein includes, for example, one or more fields associated with an email message, indicating one or more direct or indirect or “blind” intended recipients of the email message; for example, the “TO” field, the “CC” field, and/or the “BCC” field of an email message; and including fields having other field-names that are used to represent intended recipient(s) of the email message.

At an overview, some embodiments of the invention allow a user (namely, a sender) to compose an electronic mail (email) message using a client device (e.g., a computer, a PDA device, a mobile phone, or the like). The sender may type, in the recipient fields, one or more email addresses, and/or one or more telephone numbers. Once the sender commands the email client to send out the message, an email adaptor intervenes and takes control over the execution. The email adaptor identifies and extracts the telephone number from the recipient fields, and normalizes or re-formats the telephone number in accordance with pre-defined rules. The email adaptor sends the telephone number as a query to a remote server associated with a remote data repository which includes telephone numbers associated with corresponding email addresses. The remote server searches in the remote data repository for an email address which corresponds to the telephone number of the query (“a matching email address”). The web server sends to the email adaptor a response including the matching email address. The email adaptor replaces, in the email message, the telephone number with the matching email address. Optionally, the email adaptor adds or inserts or attaches an advertisement to the email message (e.g., based on a contextual analysis of the email message). Optionally, the email adaptor stores in a local cache a copy of the telephone number and the matching email address. The email adaptor returns the control to the email client, which proceeds to send out the email message, in which the telephone number was replaced by the matching email address.

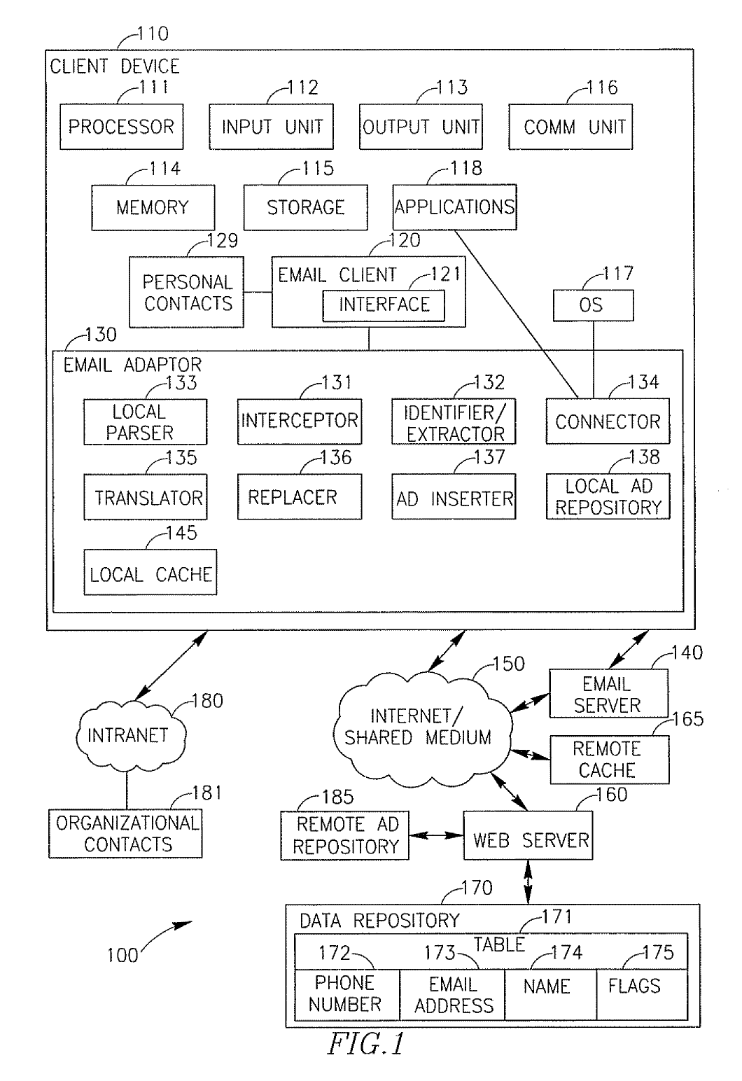

FIG. 1 schematically illustrates a block diagram of a system 100 able to handle electronic mail in accordance with some demonstrative embodiments of the invention. System 100 includes a client device 110, for example, a computing device, a computer; a Personal Computer (PC), a mobile computer, a portable computer; a laptop computer, a notebook computer, a tablet computer, a handheld computer, a handheld device, a Personal Digital Assistant (PDA) device, a handheld PDA device, an on-board device, an off-board device, a hybrid device, a vehicular device, a non-vehicular device, a mobile or portable device, a non-mobile or non-portable device, a wireless communication station, a wireless communication device, a cellular telephone, a wireless telephone, a Personal Communication Systems (PCS) device, a PDA device which incorporates a wireless communication device, a wired or wireless handheld device (e.g., BlackBerry, Palm Treo), a Wireless Application Protocol (WAP) device, or the like.

Device 110 includes, for example, a processor 111, an input unit 112, an output unit 113, a memory unit 114, a storage unit 115, and a communication unit 116. Device 110 may optionally include other suitable hardware components and/or software components.

Processor 111 may include, for example, a Central Processing Unit (CPU), a Digital Signal Processor (DSP), one or more processor cores, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 111 may execute instructions, for example, of an Operating System (OS) 117 of device 100 or of one or more software applications 118.

Input unit 112 may include, for example, a keyboard, a keypad, a mouse, a touch-pad, a track-ball, a track-wheel, a thumb-wheel, a scroll-wheel, a stylus, one or more buttons or sliders, a microphone, or other suitable pointing device or input device. Output unit 113 may include, for example, a monitor, a screen, a Cathode Ray Tube (CRT) display unit, a Liquid Crystal Display (LCD) display unit, a plasma display unit, a projector, a projection device, a television, a High Definition Television (HDTV) display unit, one or more audio speakers, or other suitable output devices.

Memory unit 114 may include, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units or storage units. Storage unit 115 may include, for example, a hard disk drive, a floppy disk drive, a Compact Disk (CD) drive, a CD-ROM drive, a Digital Versatile Disk (DVD) drive, a magnetic storage device, an optical storage device, a storage device utilizing removable storage mediums or storage articles, or other suitable removable or non-removable storage units.

Communication unit 116 may include, for example, a wired or wireless Network Interface Card (NIC), a wired or wireless modem, a wired or wireless router or switch or hub, a wired or wireless receiver and/or transmitter, a wired or wireless transmitter-receiver and/or transceiver, a Radio Frequency (RF) communication unit or transceiver, or other units able to transmit and/or receive signals, blocks, frames, transmission streams, packets, messages and/or data. Optionally, communication unit 116 may include, or may be associated with, one or more antennas, for example, a dipole antenna, a monopole antenna, an omni-directional antenna, an end fed antenna, a circularly polarized antenna, a micro-strip antenna, a diversity antenna, or the like.

In some embodiments, the components of device 110 may be enclosed in a common housing, packaging, or the like, and may be interconnected or operably associated using one or more wired or wireless links. In other embodiments, components of device 110 may be distributed among multiple or separate devices or locations, may be implemented using a client/server configuration, may communicate using remote access methods, or the like.

An email client 120 runs on device 100, and allows a user to compose, edit, send, receive, store, search, manage, and perform other operations on email messages. In some embodiments, the email client 120 is implemented using a stand-alone email application, for example, Microsoft Outlook, Microsoft Outlook Express, Mozilla Thunderbird, Eudora, or the like. For example, the email client 120 is a locally-installed software application, stored on the storage unit 115 and locally executed by the processor 111. In other embodiments, the email client 120 is implemented using web-based email (web-mail), for example, Google Gmail, Yahoo! Mail, Hotmail, or the like. The web-mail is accessible and operable through a web browser (erg., Internet Explorer, Mozilla FireFox, Netscape, Opera, or the like). Other types of email client 120 may be used.

The email client 120 may present to the user an interface 121, for example, including a Graphical User Interface (GUI) having fill-able fields buttons and click-able buttons, allowing the user to perform operations with regard to emails. For example, interface 121 allows the user to create or compose a new email, to reply to a received email, to forward a received email, to re-send a previously-sent email, to search emails, to archive emails, to associate emails with keywords or tags, to delete emails, to move emails among folders, to check for new emails, to save and edit drafts of emails, to export or import emails, to manage an emails address book, or the like. When composing or editing an email, the interface 121 allows the user to type text (e.g., to be transferred as plain-text, as Rich Text Format (RTF), as HTML, or the like), to edit text, to attach one or, more files, to remove attached files, to check spelling and grammar, to set an email priority level, to digitally sign an email, to encrypt an email, or the like.

The interface 121 presents to the user, for example, a window portion or a field in which the user may type text; a “TO” field, a “CC” field and/or a “BCC” field (“recipient fields”), in which the user may type indications of one or more direct or indirect or hidden recipients, respectively; and a “SEND” button, which the user may use to indicate that the user finished to compose the email and commands the email client 120 to send out the email to the recipient(s).

The email client 120 allows the user to create, modify, delete, and otherwise manage an personal contacts 129. For example, the user may store the email address “Condoleezza.Rice@WhiiteHouse.gov” in the personal contacts 129, such that the user may later select that email address from a list of email addresses, instead of manually typing that email address. Additionally, through the personal contacts 129, the user may create a nickname (e.g., “Condi”) to be associated with that email address; the user may later type the nickname in the recipient fields, and the email client 120 may replace the nickname with the email address associated therewith. Optionally, in addition to or instead of a local list of personal contacts 129, a list of organizational contacts 181 may be accessible by the email client 120, for example, through an enterprise intranet 180 or other local (e.g., non-Internet) area network. The organizational contacts 181 may store email addresses, associated with names and/or nicknames, that are exclusively created and accessed only by a group of users having access to the organizational address book of contacts 181 (e.g., employees of the relevant organization).

In accordance with some embodiments, a sender is able to utilize the interface 121 of the email client 120 in order to compose an email. In one or more of the recipient fields (namely, in one or more of the “TO” field, the “CC” field, and/or the “BCC” field), the sender enters one or more of the following items: an email address of a first recipient (e.g., typed manually by the sender; typed partially by the sender and completed automatically by the email client 120 based on data from the personal contacts 129 or the organizational contacts 181; selected by the sender from the list of personal contacts 129; or selected by the sender from the list of organizational contacts 181); a nickname of a second email recipient (e.g., typed manually by the sender; typed partially by the sender and completed automatically by the email client 120 based on data from the personal contacts 129 or the organizational contacts 181; selected by the sender from the list of personal contacts 129; or selected by the sender from the list of organizational contacts 181); and/or a telephone number of a person or entity intended to receive the email.

The telephone number is entered by the sender into one or more of the recipient fields by one or more ways; for example, the telephone number may be typed manually by the sender; may be typed partially by the sender and completed automatically by the email client 120 based on data from the personal contacts 129 or the organizational contacts 181; may be selected by the sender from the list of personal contacts 129; or may be selected by the sender from the list of organizational contacts 181.

The telephone number may be entered by the sender into one or more of the recipient fields in accordance with a pre-defined format or structure, or as “free-style” typing or entering that does not necessarily adhere to a pre-defined format or structure. For example, the sender may enter the following telephone numbers into one or more of the recipient fields: “212-666-7777”, or “1-212-666-7777”, or “1212-666-7777”, or “+1 212 6667777” (e.g., using a plus sign to indicate an international dialing code), or “(212) 666 7777 (e.g., using parentheses or brackets to indicate a regional area code), or “212.666.777” (e.g., utilizing “period” characters or “minus” characters or “space” characters within the telephone number), or “1-800-FLOWERS” (e.g., utilizing letters that represent digits on a typical telephone device, optionally following an area code associated with toll-free telephone numbers), or other suitable formats.

Multiple (different) telephone number formats may be used by the sender for multiple (different) telephone numbers in an email message, or a common telephone number format may be used by the sender for multiple (different) telephone number in an email message. In some embodiments, the sender need not specifically indicate that one or more telephone numbers are included in the recipient field(s), and need not use a prefix or a suffix or other indication in proximity to the telephone number(s); for example, the sender may enter free-text information, e.g., “212 666 7777”, and need not add indications, such as, for example, “TEL 212 666 7777”.

In accordance with some embodiments of the invention, an email adaptor 130 monitors the operations that the sender performs on the email client 120, erg, the process of composing the email message using the email client 120 and/or the operation of commanding to send out the email message using the email client. In some embodiments, the email adaptor 130 is implemented as a plug-in or extension or a library associated with the email client 120. In other embodiments, the email adaptor 130 is embedded in the email client 120, e.g., such that both the email adaptor 130 and the email client 120 are implemented as an integrated application. In yet other embodiments, the email adaptor 130 is a software component which may be obtained (e.g., downloaded from the Internet, read from a CD-ROM, or the like) which may be installed on device 110, e.g., by the user of device 110, by the manufacturer of device 110, as part of the OS 117, by an Internet Service Provider (ISP) that provides Internet service(s) to device 110, or the like. In still other embodiments, the email adaptor 130 is implemented using a web-browser plug-in (for various web-browsers), Active-X control, Java applet(s), JavaScript, Jscript, ECMAScript, AJAX, Dynamic HTML, Flash, Shockwave, web applications, rich Internet applications, or the like.

The email adaptor 130 includes multiple modules, as described herein; in some embodiments, some or all of the modules of email adaptor 130 may be implemented using a single or common software component. The email adaptor 130 includes, for example, an interceptor 131, an identifier/extractor 132, a local parser 133, a connector 134, a translator 135, a replacer 136, an ad inserter 137, and a local ad repository 138.

The sender completes the composition of the email message using the interface 121 of the email client 120, and commands the email client 120 to send out the email message. For example, the sender clicks on (or otherwise selects) a “SEND” button in the email interface 121, e.g., a button in the email client 120 application, a button in the email client 120 web-mail, or the like.

The interceptor 131 intercepts the sender's command to send out the email message. In some embodiments, for example, the interceptor 131 may substantially continuously monitor clicks or operations of the sender on the email interface 121 of the email client 120, and may be adapted to capture a command to send out the email message. In other embodiments, the interceptor 131 may substantially continuously monitor the operations of the email client 120, and may be adapted to capture a situation in which the email client 120 receives firm the email interface a command to send out the email message. Upon interception of the command to send out the email message, the email adaptor 130 takes control (e.g., temporarily) over operations related to email communications, and suspends or avoids (e.g., temporarily) the actual sending of the email. Upon such interception, the email message is not immediately sent out by the email client 120, and the email message is not routed through an email server 140 (e.g., a SMTP server) of system 100.

The identifier/extractor 132 checks and determines whether or not any of the recipient fields include at least one string (e.g., a sequence of characters) that appears to be a telephone number. In some embodiments, the identifier/extractor 132 may be set to determine that none of the recipient fields include any telephone number(s), if all the information included in the recipient fields is non-numeric, e.g., does not contain at least one digit. In some embodiments, the identifier/extractor 132 may be set to determine that none of the recipient fields include any telephone number(s), if each item of the recipient fields (e.g., where items are separated by a space character, or by a comma character, or by a semicolon character) includes a “@” character (thereby indicating that such item is an email address and not a telephone number). In some embodiments, the identifier/extractor 132 may be set to determine that the recipient fields include at least one telephone number, if the information included in the recipient fields contains at least one digit, or contains a sequence of at least two digits or three digits, or the like.

If the identifier/extractor 132 determines that none of the recipient fields include any telephone number(s), then the email adaptor 130 does not attempt to extract such telephone numbers, to translate such telephone numbers into corresponding email addresses, and to replace such telephone numbers with the corresponding email addresses. Instead, the email adaptor 130 may return the execution control to the email client 120, which may proceed to send the email message in it original form, e.g., as originally composed by the sender, without modifications by the email adaptor 130.

In contrast, if the identifier/extractor 132 determines that one or more of the recipient fields include one or more telephone numbers, then the email adaptor 130 may extract such telephone numbers, may translate such telephone numbers into corresponding email addresses, and may replace such telephone numbers with the corresponding email addresses, as described herein.

Upon determination that one or more of the recipient fields include one or more telephone numbers, the identifier/extractor 132 extracts from the recipient fields one or more strings (e.g., sequences of characters) that possibly represent telephone number(s). For example, the “TO” field may include the information: “Jack@Smith.com; 212-666-7777”; the identifier/extractor 132 may determine that the information includes two items (e.g., based on the semicolon character that separates them); the identifier/extractor 132 may determine that the first item is an email address (e.g., based on the “@” character included in the first item, and optionally taking into account the period character on the right side of the “@” character); the identifier/extractor 132 may determine that the second item is possibly a telephone number, and may extract and transfer the second item (namely, “212-666-7777”) for further handling by the local parser 133 of email adaptor 130.

The local parser 133 receives from the identifier/extractor 132 one or more strings of characters, for example, one string at a time, or as a group of strings separated using a pre-defined separator. The local parser 133 re-formats each string in accordance with re-formatting rules, for example, such that substantially all strings that possible represent telephone numbers are represented in accordance with a common format. For example, the common format may be: three digits, followed by a “minus” character, followed by seven digits (e.g., “212-6667777”). For example, the local parser 133 receives from the identifier/extractor 132 the string “212 666 7777”, replaces the first space with a “minus” character, and removes the second space. For example, the local parser 133 receives from the identifier/extractor 132 the string “212.666.7777”, replaces the first “period” character with a “minus” character, and removes the second “period” character. For example, the local parser 133 receives from the identifier/extractor 132 the string “(212) 666-7777”, removes the left parentheses character, removes the right parentheses character, and replaces the space character with a “minus” character. For example, the local parser 133 receives from the identifier/extractor 132 the string “800-FLOWERS”, and uses the ITU E.161 standard (also known as ANSI T1.703-1995/1999, and ISO/IEC 9995-8:1994), or other telephone keypad standards, to replace “FLOWERS” with “3569377”.

In some embodiments, optionally, the local parser 133 may modify a telephone number string (e.g., by removing or adding or modifying a local area code, by removing or adding or modifying a national dialing code, by removing or adding a “zero” character, or the like) based on pre-provided information indicating the location of the sender, e.g., worldwide location, national location, local area location, city, area code, national dialing code, rules for adding or removing a “zero” prefix, or the like. For example, the sender may register or pre-register on a web-site, and may indicate his geographical location or the above-mentioned properties, and based on the registration information the email adaptor 130 and/or the local parser 133 may modify the telephone number string.

In some embodiments, optionally, the local parser 133 may modify a telephone number string (e.g., by removing or adding or modifying a local area code, by removing or adding or modifying a national dialing code, by removing or adding a “zero” character, or the like) based on pre-provided information indicating the location of the recipient, e.g., worldwide location, national location, local area location, city, area code, national dialing code, rules for adding or removing a “zero” prefix, or the like. For example, the recipient may register or pre-register on a web-site, and may indicate his geographical location or the above-mentioned properties, and based on the registration information the email adaptor 130 and/or the local parser 133 may modify the telephone number string.

In some embodiments, optionally, information collected regarding the sender (e.g., during a registration process) may be stored locally (e.g., on the client device 110 of the sender) or remotely (e.g., on web server 160 and/or data repository 170). Additionally or alternatively, information collected regarding the recipient (e.g., during a registration process) may be stored locally (e.g., on a client device of the recipient) or remotely (e.g. on web server 160 and/or data repository 170).

In some embodiments, the local parser 133 further modifies strings representing telephone numbers, based on information received from the connector 134. The connector 134 is a module of email adaptor 130 able to obtain from the OS 117 and/or from the email client 120 and/or from other software applications 118 information which may be used by the local parser 133 to further modify strings representing telephone numbers. For example, the connector 134 may determine that the current time zone as defined in the OS 117 is ten hours prior to Greenwich Mean Time (GMT), and that therefore the sender is located in Hawaii; accordingly, the local parser 131 may determine that telephone numbers entered by the sender typically include ten digits, or that international telephone numbers begin with “011” For example, the connector 134 may determine that the current time as defined in the OS 117 is “Jerusalem daylight time”, and that OS 117 presents to the sender an interface with a “Hebrew” language code; accordingly, the local parser 131 may determine that telephone numbers entered by the sender typically include nine or ten digits, and that international telephone number begin with certain pre-defined prefix items (e.g., “00”, “013”, “014”, “015” or the like).

In some embodiments, the connector 134 may analyze data or properties or settings of a fax software application, a modern software application, an Internet connection dialer application, a Dial-Up Networking (DUN) application, or the like, in order to identify other local information which may be utilized by the local parser 133; for example, the connector 134 may determine that a fax software application installed on the device 110 has a user-configured setting that indicates that the user is located within area code “03” and is located in the Israel; accordingly, the local parser 133 may determine that seven-digits strings represent a local telephone number in the “03” area code of Israel, may add a prefix “03” to such seven-digits strings, or may add a prefix “972-3” (where 972 is the international telephone code of Israel) to such strings (e.g., for translation purposes). Other information obtained by the connector 134 may be used by the local parser 133 to re-format and/or modify strings representing telephone numbers.

Optionally, the connector 134 may obtain data from a local database or a remote database (e.g., of web server 160 or data repository 170); the obtained data may include, for example, personal data related to the sender and/or the recipient, telephone area code associated with the sender and/or the recipient, national dialing code associated with the sender and/or the recipient, personal configuration by the sender and/or recipient (e.g., indicating whether or not to add or remove a “zero” character), or other suitable information.

The local parser 133 passes a parsed (e.g., re-formatted and/or modified) string, representing a telephone number, to the translator 135. The translator 135 creates and sends out a query, to inquire whether the parsed string matches a known email address. The query is sent, for example, through a shared medium 150 (e.g., the Internet), using non-SMTP protocol (edgy, using HTTP, using HTTPS, or the like), and not through the email server 140 and/or not using an email routing system. The query is sent, for example, to a remote web server 160, which may be connected to a remote data repository 170. The web server 160 and the data repository 170 may be operated, for example, by a telephone company, by a company having directory services (e.g., “yellow pages” or “white pages” types of directory, or a proprietary directory that includes information of registered senders and/or registered receivers), by national entities, by international entities, or the like. The web server 160 receives the query sent by the translator 135 of device 110. In some embodiments, multiple databases may exist (e.g, locally and/or remotely), may be managed or operated by one or more entities, and may be queried or accessed by translator 135 and/or by web server 160.

The data repository 170 includes one or more databases (e.g., remote or non-local or non-organizational, with respect to device 110), for example, a table 171 having multiple records. A record in the table 171 includes multiple fields, for example, a telephone number field 172, an email address field 173, a name field 174, and one or more flags 175. For example, a record in table 171 includes the data “212-666-7777” or the data “1-212-666-777” in the telephone number field 172; includes the data “Jack@Smith.com” in the email address field 173; and includes the name “Jack Smith” in the name field 174. Other suitable fields may be included in table 171, for example, an address field (e.g., residential address or business address), a date of birth field, a national ID field, a social security number field, or the like. For example, in some embodiments, records in table 171 may optionally include a field indicating the country in which a user resides (e.g., the country in which a sender resides, and/or the country in which a recipient resides); and this information may be used by system 100 in order to add, remove and/or modify an international dialing code and/or a national dialing code, or to otherwise re-format a telephone number string. In some embodiments, records in table 171 may include a field indicating the city in which a user resides (e.g., the city in which a sender resides, and/or the city in which a recipient resides); and this information may be used by system 100 in order to add, remove and/or modify a local area dialing code and/or a city dialing code, or to otherwise re-format a telephone number string.

The flags field 175 may include one or more indications that may be taken into account by the web server 160 when searching for a match between a telephone number and an email address. The flags field 175 of a record may store, for example: an indication that the data included in that record was entered manually by the person whose name appears in the name field 174 of that record; that the data included in that record was verified or validated and is considered reliable (e.g., based on an email validation mechanism); an indication that the data included in that record was collected from public databases; an indication that the data included in that record was collected from a national database, or from a certain directory listing; an indication that the person who owns the telephone number included in the telephone number field 172 of that record, indicated that multiple email addresses are associated with that telephone number (and the record may optionally include pointer(s) to such additional email addresses associated with that telephone number); an indication that the user whose name appears in the name field 174 requested that the data included in that record be temporarily unavailable for third parties or “hidden” or non-visible to them; an indication that that the user whose name appears in the name field 174 requested that the data included in that record shall expire at a pre-defined date and time; be and/or other suitable indications.

Based on the results of the search in the data repository 170, the web server 160 sends a response to the translator, 135 of device 110. The response is sent, for example, through the shared medium 150 (e.g., the Internet), using non-SMTP protocol, and not through the email server 140. The response may include, for example, an indication or flag indicating that the response belongs to a pre-defined type of responses.

A first type of response sent by the web server 160 to the translator 135 of device 110 is, for example, a negative response. The negative response indicates, for example, that the web server did not find an exact match, or a reliable match, between the telephone number included in the query, and any email addresses stored in the data repository 170. Based on such response, the email adaptor 130 may perform one or more operations, for example: the email adaptor 130 may notify the sender (e.g., using a pop-up window or other way) that a string in the recipient field(s) appears to be a telephone number, but does not match a known email address, and the sender is requested to re-check the relevant recipient field(s), or to otherwise command the email adaptor 130 how to proceed (e.g., to avoid replacement of that string and to return the control to the email client 120 for sending the original email message without modification). In some embodiments, optionally, if an exact match or a reliable match is not found, system 100 may send a Short Message Service (SMS) message to the recipient (based on the telephone number string that represents that recipient, as entered by the sender), notifying the recipient by SMS that a sender attempts to send an email to the recipient based on the recipient's telephone number, and further inviting the recipient to register (e.g., using web server 160) so that his email address be associated with his telephone number. Additionally or alternatively, if an exact match or a reliable match is not found, system 100 may initiate an automatic telephone call to the recipient (based on the telephone number string that represents that recipient, as entered by the sender), notifying the recipient using a pre-recorded voice message that a sender attempts to send an email to the recipient based on the recipient's telephone number, and further inviting the recipient to register (e.g., using web server 160) so that his email address be associated with his telephone number.

A second type of response sent by the web server 160 to the translator 135 of device 110, for example, indicates that the web server 170 found an exact match, or a reliable match, between the telephone number included in the query, and one or more email addresses stored in the data repository 170. Such response includes the email address(s) that match the telephone number of the query, optionally separated using a pre-defined separator if multiple email addresses are found. Based on such response, the replacer 136 of email adaptor 130 replaces, in the recipient field(s), the telephone number with the corresponding email address (or multiple email addresses) included in the response. Upon replacement, the control may be returned to the email client 120, for sending out the modified email message. In some embodiments, an email address may be associated with one telephone number or with multiple telephone numbers; in some embodiments, a telephone number may be associated with one email address or with multiple email addresses.

A third type of response, for example, indicates that the web server found one or more semi-reliable email addresses, that are possibly associated with the telephone number of the query. Based on such response, the email adaptor 130 may perform one or more operations, for example: the email adaptor 130 may present a question to the sender, to further inquire about possible area code or international telephone code, and may possibly re-submit a revised query to the web server 160 based on the new input from the sender. Additionally or alternatively, the email adaptor 130 may present to the sender a list of the one or more semi-reliable email addresses that were found, and may allow the sender to select from the list one or more email addresses to whom the email message is to be sent.

In some embodiments, optionally, the ad inserter 137 of the email adaptor 130 may further modify the email message prior to returning the control to the email client 120 for sending out the email message. For example, the ad inserter 137 may obtain textual items, graphical items, files (e.g., a word processing file, or the like) and/or other items or files which may be appended at the end of the email message, or which may be attached to the email message as attachment, possibly representing an advertisement or a sponsorship. In some embodiments, the advertisement may be obtained from a local ad repository 138, which may be installed in device 110 together with the installation of the email adaptor 130. In other embodiments, the advertisement may be obtained from a remote ad repository 185, either directly by the email adaptor 130 (egg, over the shared medium 150), or indirectly (for example, using the web server 160, optionally including the obtained ad in the response sent by the web server 160 to the email adaptor 130). In some embodiments, the ad is inserted into the email message or attached to the email message prior to the sending out of the email message by the email client 120, prior to the email message being transferred out of device 110, and/or prior to the email message reaching an email server 140 (e.g., a SMTP server). Optionally, an ad may be associated with one or more parameters indicating properties of the ad, indicating the number of times that the ad may be inserted (e.g., a quota of “impressions” of the ad), indicating the types of emails in which the ad may be inserted, indicating conditions or criteria associated with insertion of the ad, or the like. Optionally, ads may be selected based on properties, criteria, or personal information of the sender and/or the recipient.

In some embodiments, optionally, the ad may be selected based oil contextual analysis of at least a portion of the email message, or based on contextual analysis of at least a portion of a content or file attached to the email message. For example, the email message may include the phrase “Would you like to have lunch today?”, and based on a contextual analysis an ad for a chain of restaurants (e.g., Burger King) may be inserted to the email message prior to its sending out by the email client 120. In some embodiments, optionally, the ad may be selected based on information that the sender provided to the email adaptor 130, e.g., upon installation of the email adaptor 130 on device 110; for example, the sender may indicate a list of hobbies, and an ad may be selected from a group of advertisements associated with one of these hobbies. In some embodiments, the sender may pre-select areas of interest in which he would like the selected ads to be. In some embodiments, ads are inserted only to email messages sent by a sender that does not pay a fee (e.g., to the operator of the web server 160 and/or the data repository 170), and ads are not inserted to email messages sent by a sender that pays a fee (e.g., to the operator of the web server 160 and/or the data repository 170). In some embodiments, ads are selected based on information that exists with regard to the recipient(s), and not necessarily based on information that exists with regard to the sender; for example, the data repository 170 may indicate that a telephone number is associated with a name “Jack Smith, Attorney at Law”, and an ad relating to a new legal book is inserted to email message(s) sent to that recipient. Various methods may be used, alone or in combination, to select an ad for insertion into an outgoing email message.

In some embodiments, web server 160 may optionally include a remote parser 161, able to further perform re-formatting or modification of the query received from device 110, prior to searching the data repository 170 for an email address that matches the telephone number of the query. For example, the web server 160 and the data repository 170 may be located in the United States, and may handle queries received from devices worldwide. A record in the data repository may include, for example, the telephone number “972-3-6667777” associated with the email address “Jack@Smith.com” and with the person “Jack Smith” that resides in Tel Aviv, Israel. The web server 160, located in the United States, may receive a query that includes the string “03-6667777” (e.g., optionally after a previous parsing by the local parser 133 of the email adaptor 130). The remote parser 161 of web server 160 may determine, for example, based on analysis of the IP address of device 110 (e.g., based on the IP address associated with the query received from device 110), that the sender and device 110 are located in Israel. This information may trigger the remote parser 161 to utilize a pre-defined rule, that replaces the prefix “03” (which is a local area code in Israel) with the prefix “972-3” (which indicates the country code of Israel, followed by the local area code without the leading zero). The remote parser 161 may thus re-format the received query of “03-6667777” into the string “972-3-6667777”. The web server 160 may then search in the data repository 170, for email address(es) that match the modified string, instead of or in addition to searching for email addressees) that match the string as received in the query from device 110. Other information or rules may be used by the remote parser 161, for example, to support international or multi-national translation of telephone numbers into email addresses.

Upon or after replacement of a telephone number in the recipient field(s) with a corresponding email address, one or more operations may be performed with regard to the presentation or non-presentation of the replacement email address to the sender, for example, in the “SENT EMAILS” folder of the email client 120. In some embodiments, the sent email message may show, in the “SENT EMAILS” folder of the email client 120, the original telephone number in the recipient field(s), and the replacement email address may be “hidden” from the sender or may not be retrieved by the sender. In other embodiments, if the intended recipient indicated to the data repository 170, that the intended recipient does not wish that her email address be visible to senders (e.g., as may be indicated using a flag 175 in the table 171), then the sent email message may show, in the “SENT EMAILS” folder of the email client 120, the original telephone number in the recipient field(s), and the replacement email address may be “hidden” from the sender or may not be retrieved by the sender. In yet other embodiments, the sent email message may show, in the “SENT EMAILS” folder of the email client 120, the replacement email address, instead of or in addition to the original telephone number; for example, the recipient field may show “Jack@Smith.com—converted from (212) 666-7777”. In still other embodiments, suitable presentation methods of the telephone number and/or the corresponding email address may be used, for example, based on properties of the sender (e.g., a premium user that pays a fee, a user that does not pay a fee, a user that requested to view the corresponding email address, or the like), based on properties of the recipient (e.g., a premium user that pays a fee, a user that does not pay a fee, a user that requested that his email address remain hidden from senders, a user that requested that her email address be visible to senders, or the like), and/or based on other criteria. In some embodiments, optionally, one or more of the described functions or features may be available to premium users (e.g., who paid a fee to the operator of web server 160 and/or data repository 170), whereas one or more other functions or features may be available to all types of users.

Upon or after translation of a telephone number with a corresponding email address, one or more operations may be performed with regard to the presentation or non-presentation of the replacement email address to the sender, for example, in the relevant recipient fields. In some embodiments, the email message may show the original telephone number in the recipient field(s), and the replacement email address may be “hidden” from the sender or may not be retrieved by the sender. In other embodiments, if the intended recipient indicated to the data repository 170, that the intended recipient does not wish that her email address be visible to senders (e.g., as may be indicated using a flag 175 in the table 171), then the email message may show the original telephone number in the recipient field(s), and the replacement email address may be “hidden” from the sender or may not be retrieved by the sender. In yet other embodiments, the sent email message may show the replacement email address in the recipient field(s), instead of or in addition to the original telephone number; for example, the recipient field(s) may show “Jack@Smith.com—converted from (212) 666-7777”. In still other embodiments, suitable presentation methods of the telephone number and/or the corresponding email address may be used in the recipient field(s), for example, based on properties of the sender (e.g., a premium user that pays a fee, a user that does not pay a fee, a user that requested to view the corresponding email address, or the like), based on properties of the recipient (e.g., a premium user that pays a fee, a user that does not pay a fee, a user that requested that his email address remain hidden from senders, a user that requested that her email address be visible to senders, or the like), and/or based on other criteria. In some embodiments, optionally, one or more of the described functions or features may be available to premium users (e.g., who paid a fee to the operator of web server 160 and/or data repository 170), whereas one or more other functions or features may be available to all types of users.

In some embodiments, the query sent by device 110 to web server 160, and/or the response sent by web server 160 to device 110, may be encrypted for security purposes, for example, using one or more cryptographic protocols, e.g., Secure Sockets Layer (SSL), Transport Layer Security (TLS), public key cryptographic algorithms, symmetric ciphers algorithms, or the like.

In some embodiments, the query sent by device 110 to web server 160, and/or the response sent by web server 160 to device 110, may be compressed or encoded in order to reduce the number of bits occupied by the query and/or the response, using one or more compression or encoding algorithms, e.g., Lempel-Ziv (LZ), Deflate, or the like.

In some embodiments, the email adaptor 130 may commence and/or complete the translation of telephone number(s) into corresponding email address(es), and/or the replacement of telephone number(s) with corresponding email address(es), substantially immediately upon intercepting the sender's “send” command to the email client 120. In other embodiments, the email adaptor 130 may commence and/or complete the translation and/or replacement of telephone numbers with email addresses, prior to the sender's entering the “send” command in the email client 120; for example, when the sender composes the email messages and moves (e.g., using the “tab” key or using the mouse) from a first field to a second field (e.g., from the “TO” field to the “CC” field, or from the “TO” field to the message body field); when the sender changes the “focus” of the active field or active window; when the sender commands the email client 120 to save a draft of the email message for further editing and/or for sending out later; when the sender begins a process of attaching a file to the email message; when the sender requests a spell-check or a grammar-check of the email message; when the sender manually requests the email client 120 to perform “check names” or “check email addresses” (e.g., by pressing CTRL+K in Microsoft Outlook); when a pre-defined time period (e.g., one minute, three minutes, or the like) passed since the sender started to compose an email message; at pre-defined time intervals during the composition of the email message (e.g., every 45 seconds); or based on other triggering events or conditions. These and other suitable operations of the sender may be monitored and/or intercepted by the email adaptor 130, and may trigger the process of translating and/or replacing telephone numbers with corresponding email addresses. Accordingly, the translation and/or replacement may be performed prior to the sender commanding to “send” them email message, thereby allowing the translation and/or replacement to be performed in parallel to other operations (e.g., message composition) that the sender performs, and allowing a faster sending out of the email message once the sender commands the email client 120 to send out the email message.

System 100 may optionally include other and/or additional components, for example, to accommodate various implementations. For example, system 100 may optionally include one or more firewall devices, e.g., software components and/or hardware components able to selectively permit or deny access to web server 160 and/or data repository 170, using packet filters, network layer filters, stateful filters, circuit level firewalls, application layer filters, proxy-based firewalls, or the like. Optionally, web server 160 and/or data repository 170 may be implemented using multiple devices, a server farm, a cluster of computers or servers, or the like; optionally utilizing one or more load balancers able to spread or distribute computing work across multiple resources. In some embodiments, in order to provide responses to telephone number queries of device 110, the system 100 may utilize client/server architecture, Peer to Peer (P2P) architecture, multicast or unicast transmissions, push or pull technologies, or other suitable system architectures.

In some embodiments, system 100 may optionally include and/or utilize one or more cache mechanisms or proxy mechanisms, for example, to allow re-utilization of previously-translated information and faster translation of telephone numbers. For example, optionally, a local cache 145 may be used in device 110, e.g., created and/or managed and/or updated (e.g., periodically) by the email adaptor 130. The local cache 145 may store a local copy of previously-translated telephone numbers with their corresponding email addresses. In a subsequent email message, once a telephone number is identified and extracted by the email adaptor 130, the email adaptor 130 first checks in the local cache 145 for a corresponding email address from a previous translation process; and only if the local cache 145 does not include the requested telephone number and its corresponding email address, a query is sent from the device 110 to the remote web server 160. The local cache 145 may be managed and/or updated periodically by the email adaptor 130.

Additionally or alternatively, one or more remote cache units may be used, e.g., external to the device 110, for example, at the intranet level, at the organization level, at the ISP level, at the country level, at an international level, or the like. For example, web server 160 may be associated with a cache unit, e.g., a remote cache 165, which may be local for the web server 160 and remote for the client device 110. The remote cache 165 may store a copy of previously-translated telephone numbers and their corresponding email addresses. In some embodiments, optionally, the remote cache 165 may include frequently-requested telephone numbers that are typically entered by multiple senders (e.g., “1-800-FLOWERS”) and are frequently searched by the web server 160 in the data repository 170. When the web server 160 receives a query from device 110, the web server 160 may first check in the remote cache 165 for a corresponding email address from a previous translation process; and only if the remote cache 165 does not include the requested telephone number and its corresponding email address, a query is initiated from the web server 160 to the data repository 170. Other cache mechanisms or cache rules may be used.

In some embodiments, users may be allowed to access the data repository 170, in order to add, modify and/or delete records associated with themselves. For example, a user may use a web browser to access a web-site, in which the user may enter his telephone number (e.g., “212-666-7777”), and one or more email addresses associated with his telephone number (e.g., “Jack@Smith.com”); and optionally other personal information (e.g., name, address, or the like). The web-site may use a manual or automatic validation mechanism, for example, to verify the correctness of the information entered by the user. For example, the web-site may automatically send an email message to the email addressed entered by the user, asking the user to verify that he received correctly the email message, e.g., by entering into the web-site a code send to the user by email.

Additionally or alternatively, a telephone call may be placed to the telephone number entered by the user, in order to validate the telephone number's correctness and/or to verify the identity of the user; the telephone call may be manual (e.g., by a customer service representative), or automated (e.g., using a computerized telephone system that dials the telephone number, plays an audio version of the email address as entered, and asks the user to press a pre-defined key on his telephone keypad for verification).

Optionally, validation may be performed using a SMS message. For example, system 100 may send to the telephone number entered by the user; the SMS message may include a unique code generated by system 100; the user receives the SMS message; the user enters the unique code into the registration web-page to validate his registration, or sends back a reply SMS to validate his registration.

Additionally or alternatively, the web-site may require that the user utilizes a credit card, a debit card, an online payment method (e.g., PayPal), or other monetary article in order to verify the identity of the user or the correctness of information entered by the user. In some embodiments, a sender that typed a telephone number, which was replaced by an email address, which turned out to be correct or incorrect, nay be able to contact the operator of the web server 160 and/or the data repository 170, in order to indicate (e.g., to provide feedback) that the translation was indeed correct or incorrect, respectively. Other verification methods and validation methods may be used.

In some embodiments, a telephone number may be associated with one or more email addresses, in the data repository 170. For example, data repository 170 may reflect that the user whose name is “Jack Smith” is associated with the telephone number “212-666-7777”, which in turn is associated with multiple email addresses, e.g., “Jack@Smith.com” and “JackSmith@Gmail.com”.

In some embodiments, an email address may be associated with one or more telephone numbers, in the data repository 170. For example, data repository 170 may reflect that the user whose name is “Jane Smith” is associated with the email address “Jane@Smith.com”, which in turn is associated with multiple telephone numbers, e.g., “212-555-8888” and “718-444-9999”.

In some embodiments, email adaptor 130 may utilize one or more functions or modules to identify, extract, parse and/or reformat telephone number(s) from strings or characters typed by the sender in one or more recipient fields, and/or to “normalize” the extracted telephone numbers in accordance with a pre-defined structure or format.

In some embodiments, email adaptor 130 may utilize one or more functions or modules to add a prefix to the extracted and/or re-formatted telephone number, for example, a local area code prefix and/or a country code prefix. For example, email adaptor 130 may extract the telephone number “666-7777” from a recipient field; may determine that the sender is located in Tel-Aviv, Israel (e.g., based on a settings of a facsimile application installed on the client device 110, based on pre-defined settings that the sender selected upon installing the email adaptor 130, or the like), and may thus add the prefix “3” to indicate a local area code. The email adaptor 130 may further determine that the sender is located in Israel (e.g., based on the facsimile application settings, or based on pre-defined settings that the sender selected upon installing the email adaptor 130 or based on a time zone or country code defined in the OS 117), and may thus add the additional prefix “972” to indicate the country code, the extracted telephone number “666-7777” may thus be converted into “3-666-7777” and may be submitted as query to a data repository 170 that includes national (e.g., Israeli) telephone numbers. Additionally or alternatively, the extracted telephone number “666-7777” may thus be converted into “972-3-666-7777” and may be submitted as query to a data repository 170 that includes mnulti-national telephone numbers. In some embodiments, optionally, the query may include a first field or data item representing the telephone number, a second field or data item representing the local area code, and a third field or data item representing the country code; other suitable structures may be used.

In some embodiments, re-formatting and/or parsing and/or modification of the telephone number entered by the sender, may be performed using an algorithm that takes into account personal information that system 100 has with regard to the sender and/or the receiver (e.g., obtained using a registration process), for example, country, city, geographical location (optionally based on IP number), local area code, national area code, or the like.

In some embodiments, email adaptor 130 may differentiate its operation based on whether or not the sender is a “premium” user (e.g., who pays a one-time fee or a periodic fee) or a “non-premium” user (e.g., who uses the email adaptor without payment). For example, email adaptor 130 may add advertisement(s) to email messages sent by a non-premium user, but may not add advertisement(s) to email messages sent by a premium user. Additionally or alternatively, email adaptor 130 may expire after a “trial period” (e.g., 30 days from installation or first usage) when used by a non-premium user. Additionally or alternatively, email adaptor 130 may allow a non-premium user to send out a pre-defined number of email messages per day that include telephone number(s) in the recipient field(s), e.g., up to ten email messages per day. Other differentiation may be used between premium users and non-premium users.

In some embodiments, a user may purchase a pre-defined number of “telephone number translations”, for example, the sender may purchase in advance the right to send out email messages that require up to fifty conversions of telephone numbers into corresponding email addresses. In some embodiments, a “pay per use” or “pay per translation” scheme may be utilized, such that the sender is billed per each telephone number that was actually translated into an email address. Email adaptor 130 may track the amount of email messages that required telephone number translation, e.g., using a locally encrypted counter parameter.

In some embodiments, email adaptor 130 may utilize one or more functions or modules to check whether the local cache 145 is updated, e.g., with respect to a periodical and/or schedule update process. In some embodiments, email adaptor 130 may utilize one or more functions or modules to send the telephone number query to the local cache 145 and/or the remote cache 165, e.g., instead of or in addition to sending the telephone number to the web server 160 to initiate a search in the data repository 170. In some embodiments, email adaptor 130 may utilize one or more functions or modules to synchronize among the local cache 145, the remote cache 165, the personal contacts 129, and/or other sources which may be used for translation of telephone numbers into corresponding email addresses. In some embodiments, a “live update” or “dynamic update” mechanism may be used in order to update or upgrade the version of the email adaptor 130.

Although portions of the discussion herein relate, for demonstrative purposes, to sending an email message to a recipient based on a telephone number of the recipient which is entered by the sender, embodiments of the invention are not limited in this regard, and may be used, for example in conjunction with sending an email message to a recipient based on a string (e.g., a non telephone number string) of the recipient which is entered by the sender. The string may be or may include, for example, a number (e.g., not necessarily a telephone number); a nickname; a combination of letters and/or digits and/or characters; an indication used by an IM system to identify a user (e.g., ICQ1234567 which corresponds to a user of the ICQ instant messaging system); a unique number or word or phrase; a string that commences with a pre-defined character, or sub-string (e.g., the “*” character). Optionally, unique strings or easily-remembered strings (e.g., the string “*1234”, the string “*7777”, or the like) may be offered for sale by the operator of web server 160 and/or data repository 170, and may be purchased by potential recipients for a premium fee. Accordingly, in such embodiments, the terms “telephone number” and “telephone number string” as used herein may optionally include such other non-telephone-number strings.

Some embodiments may be implemented as a proprietary or stand-alone web-mail service or web-mail web-site (e.g., not necessarily as a plug-in to an email software, or as an extension to a traditional web-mail service), which may allow the user to send an email message in which a telephone number is entered in one or more recipient fields. Other embodiments may be implemented as an extension module or an additional module to traditional web-mail services, or as a built-in or integrated module in web-mail services. Still other embodiments may be implemented as a plug-in to email software applications, or as a built-in or integrated module in email software applications. Some embodiments may be implemented as a web-mail service or web-mail web-site (e.g., Gmail, Hotmail, Yahoo! Mail, or the like), or as a modified or upgraded version thereof, or as a premium version thereof, which may allow the user to send an email message in which a telephone number is entered in one or more recipient fields.

Some embodiments may be implemented using a software component (e.g., a Java software application) and/or a hardware software component which may be included in a mobile phone, a cellular phone, a wireless communication device, a portable communication device, or the like. For example, a mobile phone may include a software component adapted to automatically perform the translation of telephone numbers into corresponding email addresses (e.g., using the web server 160, or a server or switch or router of a mobile communication system). Optionally, the mobile phone allows the sender to enter the telephone number manually, or to select the telephone number from a list of telephone numbers stored in a “phone-book” repository of the mobile phone.

In some embodiments, upon a successful translation of a telephone number into a corresponding email addresses, the email adaptor 130 may modify the personal contacts 129 of the client device 110, or may add or insert unique information into the personal contacts 129. The modified or added information may later me used by email adaptor 130 and/or system 100, for further sending or routing of email messages, since the email adaptor 130 originally created or inserted the added information. Accordingly, further email messages that are sent to such email addresses, that were added to the personal contacts 129, may be routed by system 100, may be modified by system 100 (e.g., by adding or inserting advertisements), or the like. This may be performed in various implementations, for example, in an implementation using an email software application, in an implementation using a web-mail service, or the like.

In some embodiments, one or more components of system 100 may be implemented as organizational components or enterprise components. For example, the web server 160 may be implemented as an intranet software module accessible by users of the organization; the data repository 170 may be implemented as an organizational data repository; and the translation process between telephone numbers and email addresses may be performed over the organizational intranet. Optionally, the organizational data repository may include a copy of, or a subset of, the remote data repository 170; and the organizational data repository may be periodically updated or synchronized against the remote data repository 170 (e.g., once a day, once a week, or the like.

In some embodiments, email adaptor 130 may be configured to identify and extract one or more telephone numbers that are included in portions of the email message or the email header other than the recipient field(s), for example, from the subject line of the email message, from the text portion of the email message (e.g., from the first line of the text, from the first paragraph of the text, from the entire text, or the like), from a signature portion, or the like. Such identified and extracted telephone numbers may be parsed, translated into corresponding email addresses, and inserted into one or more recipient fields (e.g., automatically, or based on the sender's response to a notification that a telephone number was identified and translated).

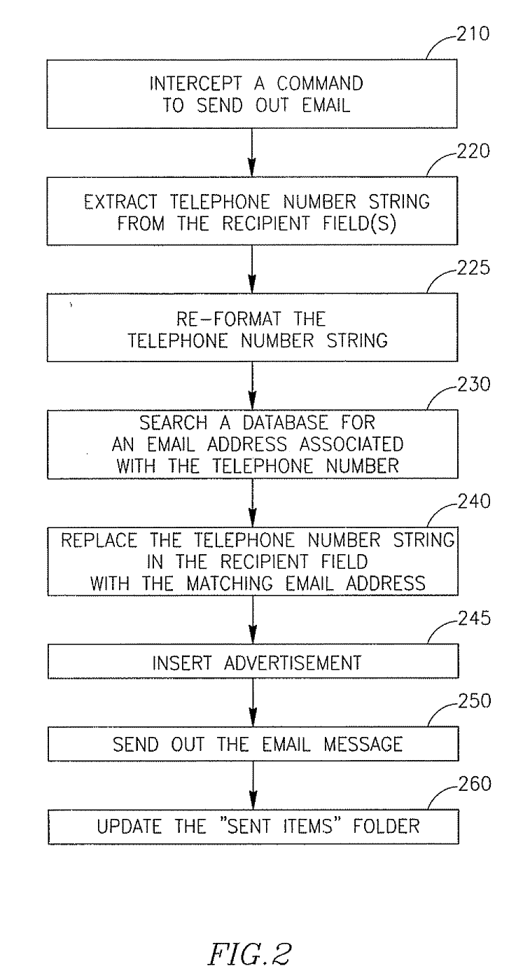

FIG. 2 is a schematic flow-chart of a method of handling electronic mail in accordance with some demonstrative embodiments of the invention. Operations of the method may be used, for example, by system 100 of FIG. 1, by device 110 of FIG. 1, by email adaptor 130 of FIG. 1, and/or by other suitable units, devices and/or systems.

In some embodiments, the method may include, for example, intercepting in an email interface of an email client a command to send out an email message (block 210). This may include, for example, talking the control from the email client, e.g., temporarily.

In some embodiments, the method may include, for example, extracting, from a recipient field of the email interface, a string representing a telephone number of an intended recipient (block 220).

In some embodiments, the method may optionally include, for example, re-formatting the string in accordance with pre-defined rules (block 225), e.g., telephone number “normalization” rules, prefix adding rules, character removal rules, character replacement rules, or the like.

In some embodiments, the method may include, for example, searching in a database, which includes at least telephone numbers and corresponding email addresses, for an email address which corresponds to the telephone number represented in the string (“a matching email address”) (block 230). This may optionally include, for example, sending a query to a remote web server associated with a remote data repository, and receiving a response from the remote web server; searching in a local cache; searching in a remote cache; or the like.

In some embodiments, the method may include, for example, replacing the string in the recipient field of the email interface with the matching email address (block 240).

In some embodiments, the method may optionally include, for example, inserting an advertisement item to the email message (block 245), e.g., based on contextual analysis of at least a portion of the email message.

In some embodiments, the method may include, for example, authorizing the email client to send out the email message (block 250), e.g., by returning the control to the email client which may thereby proceed to send the email message (which includes the matching email address in the recipient field, instead of the telephone number string).

In some embodiments, the method may include, for example, updating the “sent items” folder of the email client (block 260), egg, by storing in the “sent items” folder of the email client a copy of the email message; the recipient field of the stored copy may include, for example, the telephone number and/or the matching email address and/or an indication that the matching email address is a conversion form the telephone number.

Other suitable operations or sets of operations may be used; other orders of operations may be used; some operations may be repeated, e.g., in multiple iterations.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of embodiments of the invention have been illustrated and described herein, many modifications, substitutions, changes, and equivalents may occur to those skilled in the art. It is, therefore, to be understood that the appended claims are intended to cover all such modifications and changes.

What is claimed is:

1. A method of handling electronic mail, the method comprising:
extracting from a recipient field of an electronic mail message intended for transmission a string representing a telephone number of an intended recipient;
based on said string, obtaining an electronic mail address of the intended recipient from a remote database that associates telephone numbers with respective electronic mail addresses; and
replacing said string with said electronic mail address in the recipient field of the electronic mail message.

2. The method of claim 1, comprising:
intercepting a command to send out the electronic mail message from an electronic mail interface.

3. The method of claim 1, comprising:
after said replacing, authorizing said electronic mail interface to send out the electronic mail message.

4. The method of claim 1, wherein the extracting comprises:
identifying a sequence of characters in the recipient field which represents a telephone number based on one or more pre-defined identification rules.

5. The method of claim 1, comprising:
after the extracting and prior to the searching,
re-formatting said string in accordance with one or more pre-defined formatting rules.

6. The method of claim 5, wherein the re-formatting comprises:
performing at least one operation selected from a group consisting of:
removing a parentheses character,
replacing a parentheses character,
removing a period character,
replacing a period character,
removing a space character,
replacing a space character,
removing a minus character, and
replacing a minus character.

7. The method of claim 1, wherein the searching comprises:
transmitting a query to a remote web server associated with a remote data repository storing said database, the query comprising said string; and
receiving from the remote web server a response comprising said electronic mail address.

8. The method of claim 7, wherein the transmitting comprises:
transmitting said query to said web server prior to transmission of the electronic mail message from the electronic mail interface to an electronic mail server.

9. The method of claim 1, wherein the extracting from the recipient field comprises:
performing an operation selected from a group consisting of:
extracting from a “TO” field of the electronic mail message,
extracting from a “CC” field of the electronic mail message, and
extracting from a “BCC” field of the electronic mail message.

10. The method of claim 1, comprising:
prior to the searching, adding to said string at least one of:
a prefix representing a local area telephone code, and
a prefix representing a country telephone code.

11. The method of claim 10, wherein the adding of the prefix comprises:
adding the prefix based on at least one of:
a country code definition of an operating system on which the electronic mail interface runs,
a time zone definition of said operating system,
a language definition of said operating system,
an indication of a sender's country,
an indication of a recipient's country,
an indication of a sender's city,
an indication of a recipient's city.

12. The method of claim 1, comprising:
storing in a folder of sent electronic mail messages of said electronic mail interface a copy of the electronic mail message, wherein the recipient field of said copy includes an item selected from a group consisting of:
said string;
said electronic mail address; and
said string, said electronic mail address, and an indication that said electronic mail address corresponds to said string.

13. The method of claim 1, comprising:
adding an advertisement item to the electronic mail message.

14. The method of claim 1, wherein the adding comprises:
selecting said advertisement item from a repository of advertisement items based on at least one of:
an information item associated with a recipient of the electronic mail message,
an information item associated with a sender of the electronic mail message, and
a contextual analysis of the electronic mail message.

15. The method of claim 1, comprising:
storing in a local cache a copy of said string and said electronic mail address; and
prior to a subsequent searching of said database, searching the local cache.

16. The method of claim 1, comprising:
extracting from a recipient field of the electronic mail message intended for transmission another string comprising at least one non-digit character;
based on the other string, obtaining a translated electronic mail address of the intended recipient from a remote database that associates contact details with respective electronic mail addresses; and
replacing the other string with the translated electronic mail address in the recipient field of the electronic mail message.

17. An apparatus for handling electronic mail, the apparatus comprising:
an extractor to extract from a recipient field of an electronic mail message intended for transmission a string representing a telephone number of an intended recipient;
a translator to obtain, based on said string, an electronic mail address of the intended recipient from a remote database that associates telephone numbers with respective electronic mail addresses; and
a replacer to replace said string with said electronic mail address in the recipient field of the electronic mail message.

18. The apparatus of claim 17, comprising:
an interceptor to intercept a command to send out the electronic mail message from an electronic mail interface.

19. A communication system for handling electronic mail, the communication system comprising:
a remote database that associates telephone numbers with respective electronic mail addresses; and
a communication device comprising:
an interceptor to intercept a command to send out an electronic mail message from an electronic mail interface;
an extractor to extract from a recipient field of the electronic mail message intended for transmission a string representing a telephone number of an intended recipient;
a translator to obtain from the remote database, based on said string, an electronic mail address of the intended recipient; and
a replacer to replace said string with said electronic mail address in the recipient field of the electronic mail message.

20. The communication system of claim 19, wherein the communication device comprises a device selected from a group consisting of:
a personal computer, a laptop computer, a Personal Digital Assistant device, an electronic mail device, a wireless communication device, and a mobile phone.
